(19) United States
(12) Patent Application Publication
(10) Pub. No.: US 2014/0230934 A1
(43) Pub. Date: Aug. 21, 2014

(54) Oil stop device for connecting a hydraulic cable

(71) Applicant: Chao-Kung Chen, Changhua (TW)

(72) Inventor: Chao-Kung Chen, Changhua (TW)

(21) Appl. No.: 14/260,281

(22) Filed: Apr. 24, 2014

(30) Foreign Application Priority Data
Nov. 20, 2013 (TW) 102221642

(51) Int. Cl. F16L 19/025

(52) U.S. Cl. CPC F16L 19/025
USPC 137/798

(57) ABSTRACT

An oil stop device for connecting a hydraulic cable is provided with a needle being a hollow structure and detachably plugged in one end of the hydraulic cable, and an inner threaded portion formed inside the needle; a connecting member having an outer threaded portion extended toward one end thereof adjacent to the needle, and the outer threaded portion screwed with the inner threaded portion of the needle; and a first stop-leak ring sleeved on the outer threaded portion of the connecting member and located between the needle and the connecting member. It is easy to assemble and disassemble the hydraulic cable passed through the frame of the bicycle and the hydraulic brake. And further, it may simplify structure.

### BACKGROUND OF THE INVENTION

1. Field of the Invention

The invention relates to a bicycle, and more particularly to an oil stop device for connecting a hydraulic cable of a bicycle.

2. Description of Related Art

In general, the replacement of the hydraulic cable of a bicycle by a user, that is assembling the hydraulic cable to a hydraulic brake, is that one end of the hydraulic cable is passed through the hydraulic brake and then an oil stop is disassembled to assemble the hydraulic cable and the hydraulic brake.

However, when the hydraulic cable passes through inside a frame of the bicycle to assemble the hydraulic cable and the hydraulic brake, the direction of the hydraulic cable may not be controlled and it is not convenient to operate.

Thus, the need for improvement still exists.

### SUMMARY OF THE INVENTION

It is therefore one object of the invention to provide an oil stop device for connecting a hydraulic cable of a bicycle comprising a needle, being a hollow structure and detachably plugged in one end of the hydraulic cable, and an inner threaded portion is formed inside the needle; a connecting member, having an outer threaded portion extended toward one end thereof adjacent to the needle, and the outer threaded portion is screwed with the inner threaded portion of the needle; and a first stop-leak ring, sleeved on the outer threaded portion of the connecting member and located between the needle and the connecting member.

The above and other objects, features and advantages of the invention will become apparent from the following detailed description taken with the accompanying drawings.

### BRIEF DESCRIPTION OF THE DRAWINGS

FIG. 1 is a partial exploded view of an oil stop device for connecting a hydraulic cable according to the invention;

FIG. 2 is an outside view of the oil stop device for connecting the hydraulic cable according to the invention;

FIG. 3 is a cross section view of the oil stop device for connecting the hydraulic cable according to the invention;

FIG. 4 is an exploded view of the oil stop device for connecting a hydraulic cable and a hydraulic brake;

FIG. 5 is an outside view of the oil stop device for connecting a hydraulic cable and the hydraulic brake; and

FIG. 6 is a perspective view of FIG. 5.

### DETAILED DESCRIPTION OF THE INVENTION

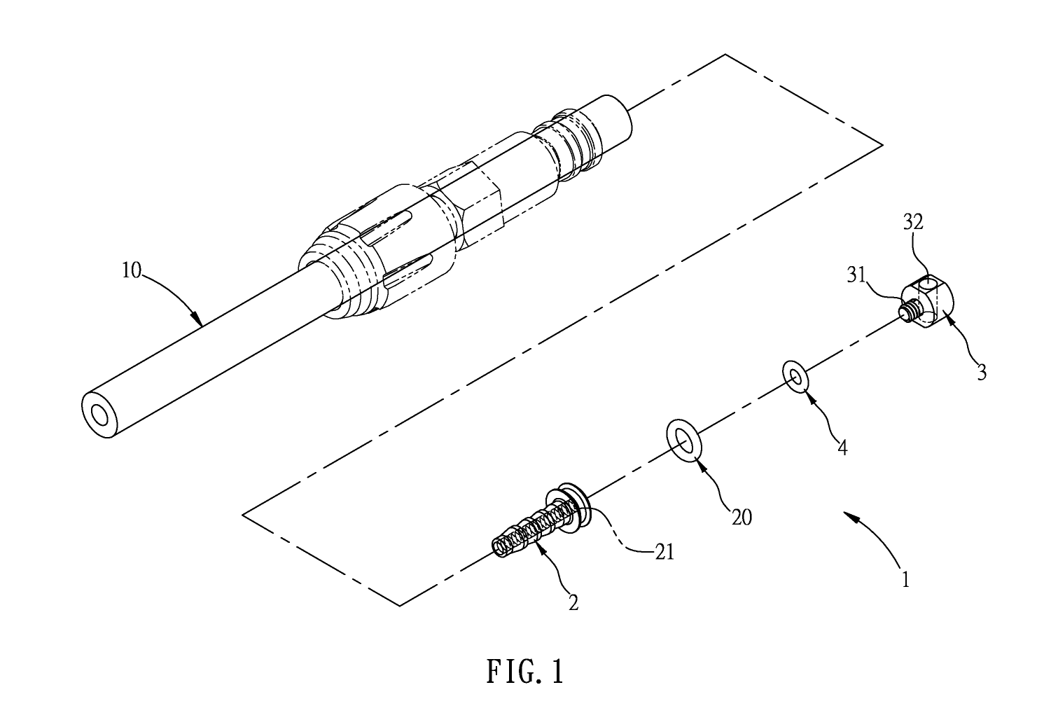

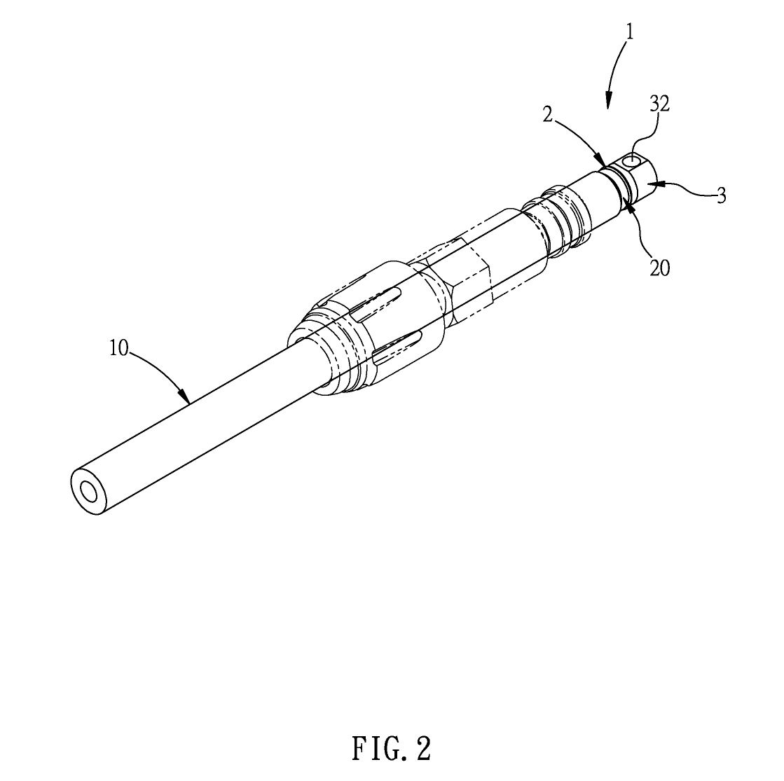

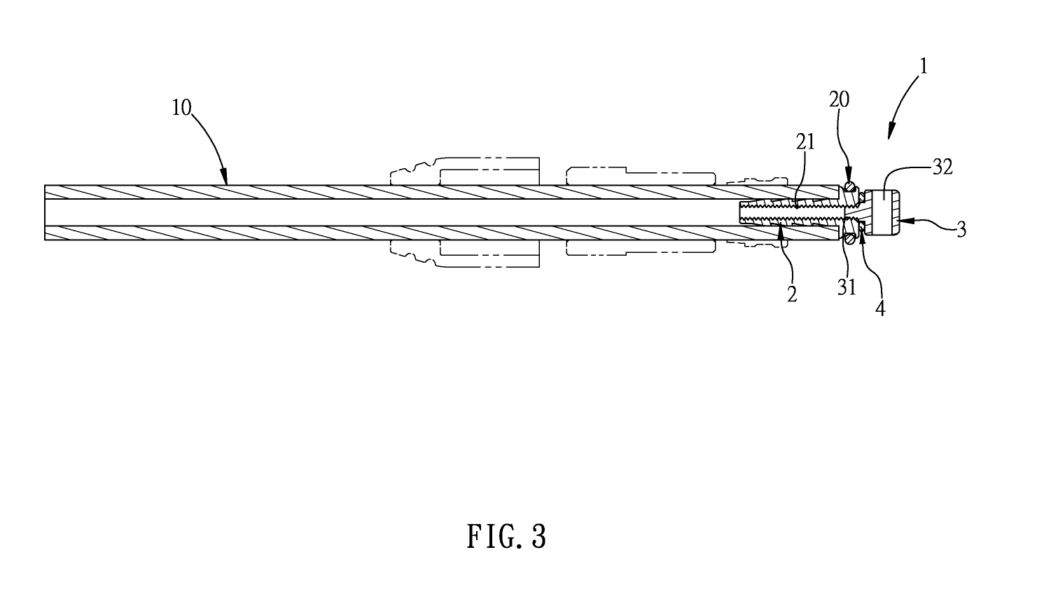

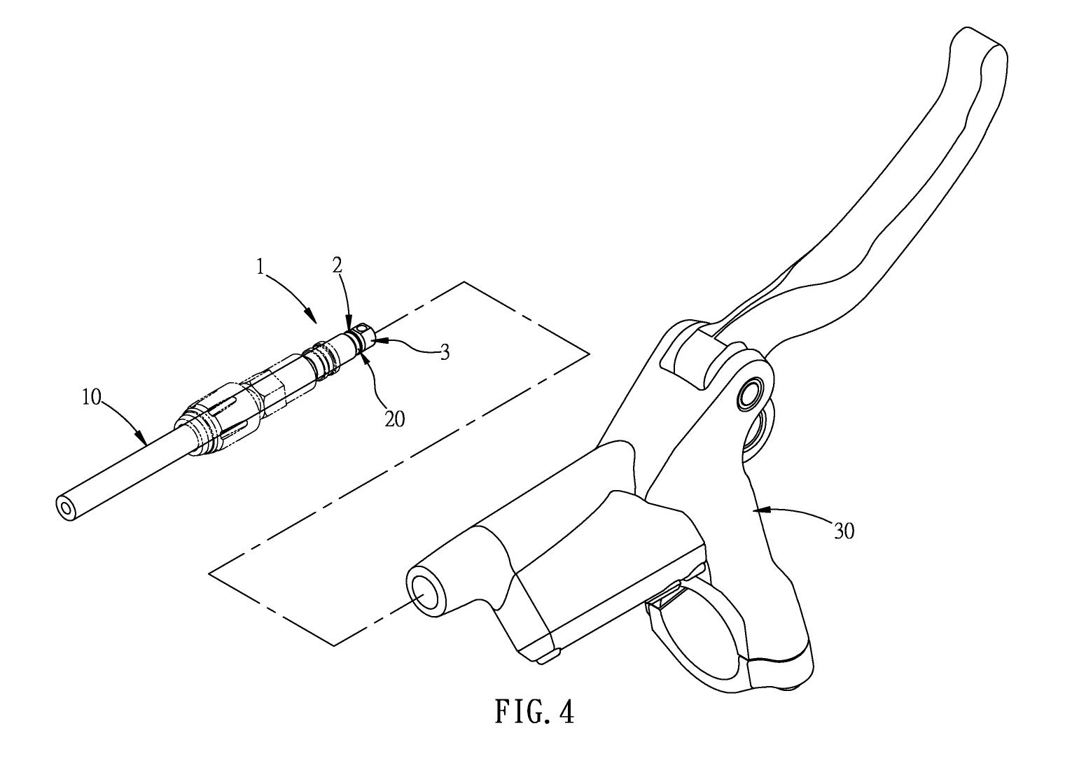

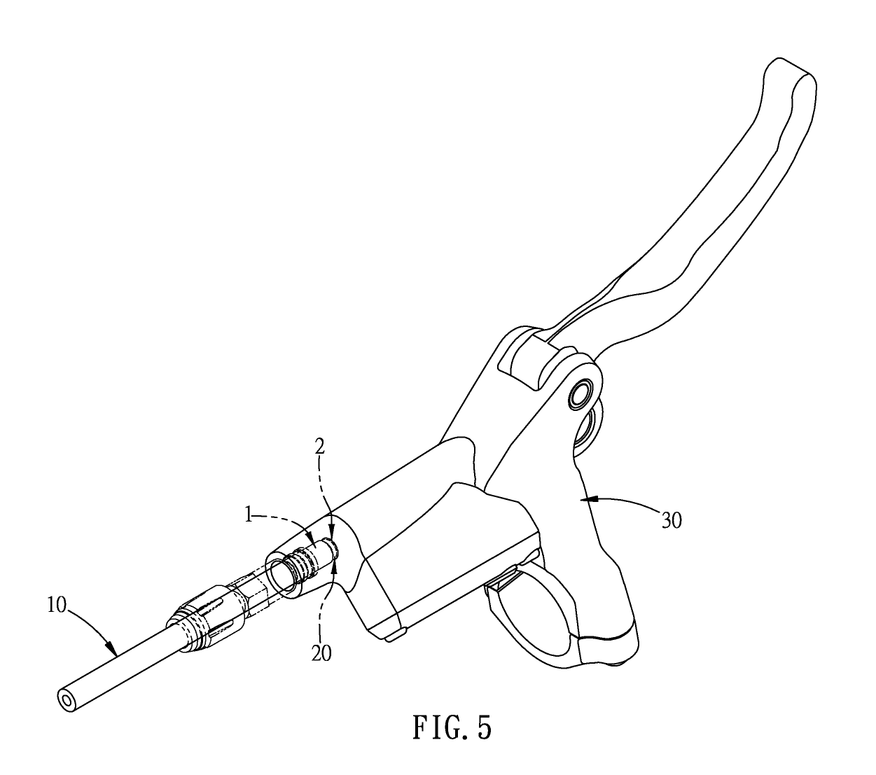

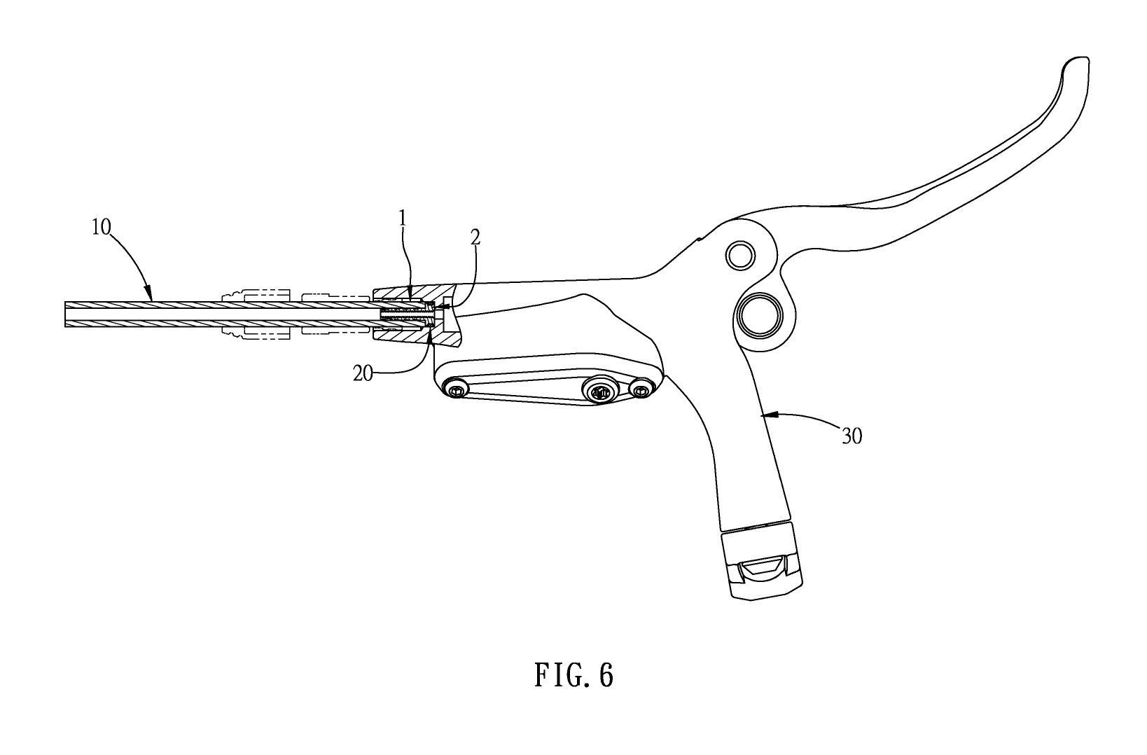

Referring to FIGS. 1 to 6, an oil stop device 1 for connecting a hydraulic cable 10 of a bicycle (not shown) in accordance with the invention comprises a needle 1, a connecting member 2, and a first stop-leak ring 3.

The needle 2 may be a hollow structure and detachably plugged in one end of the hydraulic cable 10. And an inner threaded portion 21 may be formed inside the needle 2. Furthermore, a second stop-leak ring 20, such as an O-ring (but not limited thereto), may be arranged between the needle 2 and the connecting member 3 for preventing oil in the hydraulic cable 10 from leaking.

The connecting member 3 may have an outer threaded portion 31 extended toward one end thereof adjacent to the needle 2. And the outer threaded portion 31 may be screwed with the inner threaded portion 21 of the needle 2. Besides, a connecting hole 32 may be extending from the end of the connecting member 3 away from the needle 2 and toward a direction away from the needle 2. Or a hexagonal inner threaded hole (not shown) may be arranged at the end of the connecting member 3 away from the needle 2.

The first stop-leak ring 4 may be sleeved on the outer threaded portion 31 of the connecting member 3 and located between the needle 2 and the connecting member 3 for preventing oil flowed through the needle 2 and the connecting member 3 from leaking. And the first stop-leak ring may be an O-ring, but not limited thereto.

When a hydraulic brake 30 is connected to the hydraulic cable 10 by a user, a wire (not shown) may be tied at the connecting hole 32 and the hydraulic cable 10 may be lead through inside a frame (not shown) of the bicycle to the hydraulic brake 30, and the connecting member 3 may be disassembled to make the hydraulic cable 10 and the hydraulic brake 30 be detachably fastened. And then, the wire (not shown) may be released and the connecting member 3 may be turned over based on the structure of the inner threaded portion 21 of the needle 2 and the outer threaded portion 31 of the connecting member 3 for disassembling the connecting member 3 from the needle 2 by screwing. And further, the hydraulic cable 10 and the hydraulic brake 30 may finish assembling finally.

Therefore, based on above structure of the oil stop device 1 of this invention, it is easy to assemble and disassemble the hydraulic cable 10 passed through the frame of the bicycle and the hydraulic brake 30. And further, it may achieve the effective of simplified structure.

While the invention has been described in terms of preferred embodiments, those skilled in the art will recognize that the invention can be practiced with modifications within the spirit and scope of the appended claims.

What is claimed is:

1. An oil stop device for connecting a hydraulic cable, comprising:
a needle being a hollow structure and detachably plugged in one end of the hydraulic cable, and including an inner threaded portion formed inside the needle;
a connecting member having an outer threaded portion extended toward one end thereof adjacent to the needle, and the outer threaded portion being screwed with the inner threaded portion of the needle; and
a first stop-leak ring sleeved on the outer threaded portion of the connecting member and located between the needle and the connecting member.

2. The oil stop device of claim 1, wherein an inner threaded portion is formed at the end of the connecting member away from the needle.

3. The oil stop device of claim 1, wherein a connecting hole is extending from the end of the connecting member away from the needle and toward a direction away from the needle.

4. The oil stop device of claim 1, wherein a second stop-leak ring is arranged between the needle and the connecting member.
